(19) United States
(12) Patent Application Publication
(10) Pub. No.: US 2016/0381563 A1
(43) Pub. Date: Dec. 29, 2016

(54) LOW INTERFERENCE CELLULAR DATA COMMNUNICATION IN UNLICENSED FREQUENCY SPECTRUM

(71) Applicant: Freescale Semiconductor, Inc., Austin, TX (US)

(72) Inventors: Amin Abdel Khalek, Austin, TX (US); Natraj Ekambaram, Austin, TX (US); Balaji Tamirisa, Austin, TX (US)

(21) Appl. No.: 14/753,730

(22) Filed: Jun. 29, 2015

(51) Int. Cl. H04W 16/14; H04W 56/00; H04W 72/04

(52) U.S. Cl. CPC H04W 16/14; H04W 72/0453; H04W 56/001; H04W 88/08

(57) ABSTRACT

A cellular base station communicates data using both the licensed and unlicensed frequency spectrums. For each interval of a set of intervals (such as intervals corresponding to communication of LTE frames), the base station first identifies whether signaling is detected on a specified unlicensed frequency channel (UFC). If a signal is detected, the base station communicates data only over a licensed frequency channel (LFC) for the interval, and does not employ the UFC for the interval. If no signal is detected, the base station communicates data over the interval on both the LFC and the UFC. To ensure that other devices have the opportunity to use the UFC in a timely fashion, the base station communicates data over the UFC for only a portion of the interval.

### BACKGROUND

Field of the Disclosure

The present invention relates generally to cellular data communication and more particularly to cellular data communication in an unlicensed frequency spectrum.

Description of the Related Art

Cellular carriers have conventionally employed licensed frequency bands, wherein each carrier uses a different portion of the frequency spectrum licensed by the Federal Communications Commission, to communicate data. To keep up with the increasing data demands, the carriers have adopted new communication standards, such as the Long Term Evolution (LTE) standard, that provide for more data bandwidth in the licensed frequency bands. However, as demand for cellular data continues to increase, the data bandwidth for the cellular networks will approach its theoretical limit and therefore impose a limitation on the continued evolution of mobile devices and applications.

### BRIEF DESCRIPTION OF THE DRAWINGS

The present invention may be better understood, and its numerous features and advantages made apparent to those skilled in the art by referencing the accompanying drawings. The use of the same reference symbols in different drawings indicates similar or identical items.

FIG. 1 is a block diagram of a network system in which a cellular network communicates data in both licensed and unlicensed frequency channels in accordance with at least one embodiment of the present invention.

FIG. 2 is a block diagram illustrating a frame of data communicated via a licensed frequency channel and corresponding data communicated via an unlicensed frequency channel by the cellular network of FIG. 1 in accordance with at least one embodiment of the present invention.

FIG. 3 is a block diagram illustrating communication of data by the cellular network of FIG. 1 via both a licensed frequency channel and an unlicensed frequency channel concurrent with signal transmission in the wireless local area network of FIG. 1 in accordance with at least one embodiment of the present invention.

FIG. 4 is a block diagram illustrating a setting of the length of a blank subinterval of an unlicensed frequency channel frame based on detection of signals in the unlicensed frequency channel in accordance with at least one embodiment of the present invention.

FIG. 5 is a block diagram illustrating repeated sensing of signals in the unlicensed frequency channel to increase the likelihood that a free portion of the channel can be identified in accordance with at least one embodiment of the present invention.

FIG. 6 is a block diagram of a base station of the cellular network of FIG. 1 in accordance with at least one embodiment of the present invention.

FIG. 7 is a flow diagram of a method of communicating data via an unlicensed frequency channel in a cellular network in accordance with at least one embodiment of the present invention.

FIG. 8 is a flow diagram of a method of adjusting a blank subinterval of a frame communicated via an unlicensed frequency channel in a cellular network in accordance with at least one embodiment of the present invention.

FIG. 9 is a flow diagram of a method of reserving an unlicensed frequency channel in a cellular network for communication of data in accordance with at least one embodiment of the present invention.

FIG. 10 is a flow diagram of a method of receiving data at user equipment via an unlicensed frequency channel in a cellular network in accordance with at least one embodiment of the present invention.

### DETAILED DESCRIPTION

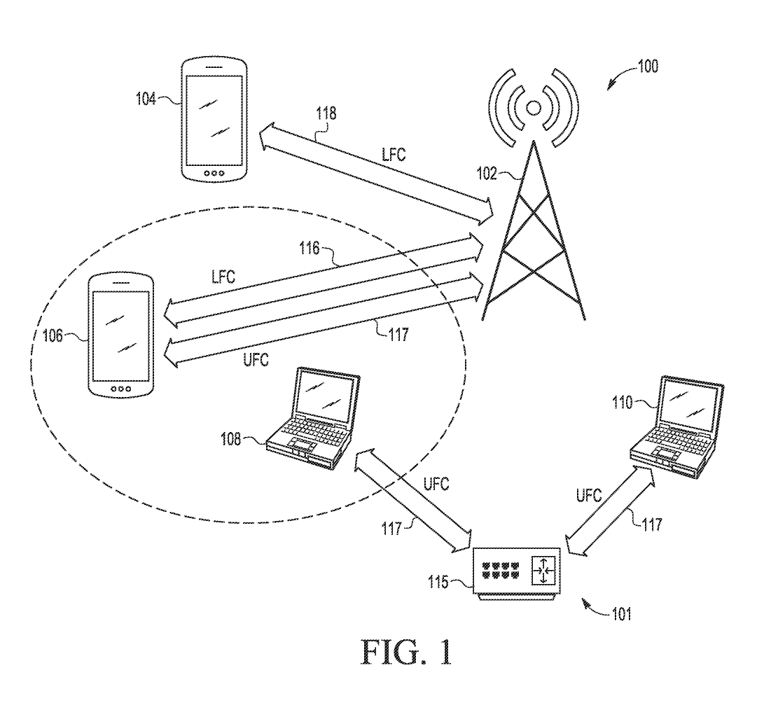

FIGS. 1-10 disclose techniques for increased throughput of cellular data from a base station to user equipment by employing both the licensed and unlicensed frequency spectrums, while ameliorating interference with other devices (e.g., wireless routers) that employ the unlicensed frequency spectrum. For each interval of a set of intervals (such as intervals corresponding to communication of LTE frames), the base station identifies whether signaling is detected on a specified unlicensed frequency channel (UFC). If a signal is detected, the base station communicates data only over a licensed frequency channel (LFC) for the interval, and does not employ the UFC for the interval. If no signal is detected, the base station communicates data over the interval on both the LFC and the UFC. To ensure that other devices have the opportunity to use the UFC in a timely fashion, the base station communicates data over the UFC for only a portion of the interval. The base station thereby increases its bandwidth for data communication, while reducing the amount of interference to other devices using the UFC.

As used herein, a licensed frequency channel is a communication channel that employs one or more frequencies that are licensed for use by a governmental agency, such as the Federal Communications Commission (FCC) in the United States. As used herein, an unlicensed frequency channel is a communication channel that employs, for communication of information, one or more frequencies that are not licensed for use by the governmental agency. Examples of a UFC in the United States include channels that use frequencies of 5.4 GHz or 5.8 GHz. Because LFCs are typically licensed to a single licensee, such as cellular carrier, the communication of data can be carefully managed and controlled, providing for reliable data communication and a good user experience. In contrast, UFCs can be used by a wide variety of devices that are controlled by disparate entities that do not coordinate their use of the UFC. Indiscriminate use of a UFC can therefore degrade the ability of one or more of these devices to effectively communicate data, resulting in a poor user experience. By using the UFC to communicate data only when the channel is not in use, and by communicating data for only a portion of the time that data is concurrently communicated over an LFC, the base station provides ample time for other devices to employ the UFC, maintaining or enhancing the user experience while increasing the amount of bandwidth available to the base station to communicate data to user equipment.

FIG. 1 illustrates a cellular network 100 and a wireless local area network (WLAN) 101 that cover at least a portion of the same geographic area in accordance with at least one embodiment of the present invention. The WLAN 101 includes a wireless router 115 and endpoints 108 and 110. For purposes of description, the endpoints 108 and 110 are illustrated as computers, but it will be appreciated that in some embodiments one or more of the endpoints 108 and 110 can be any type of equipment that can receive data from a wireless router, such as a smartphone, tablet, game console, automobile, and the like. The wireless router provides for the endpoints 108 and 110 a connection point to a wide area network (not shown) such as the Internet. For purposes of description, it is assumed that the wireless router 115 communicates with the endpoints 108 and 110 according to at least one of the Institute of Electrical and Electronics Engineers (IEEE) 802.11 standards using one or more UFCs (e.g. UFC 117).

The cellular network 100 includes a base station 102 and user equipment 104 and 106. For purposes of description, the user equipment 104 and 106 are illustrated as smartphones. However, it will be appreciated the user equipment 104 and 106 can be any device capable of receiving data via a cellular network, such as a desktop computer, laptop, tablet, automobile, gaming console, and the like. The cellular network 100 can include additional equipment not specifically illustrated at FIG. 1, including additional user equipment, additional base stations, base station controllers, mobile switching centers, and the like. The cellular network 100 is connected to one or more other networks not illustrated at FIG. 1, including the public switched telephone network (PSTN) and one or more wide area data networks such as the Internet. For purposes of description, the cellular network 100 is described as communicating data in compliance with the Long Term Evolution (LTE) communication standard. However, it will be appreciated that in other embodiments the cellular network 100 may communicate data in compliance with other standards.

The base station 102 is configured to communicate data to and from the user equipment 104 and 106. To illustrate via an example, a user of the user equipment 104 can interact with the device via one or more applications executed at the user equipment 104. These interactions result in the user equipment 104 generating requests for data from a data network such as the Internet. The user equipment 104 communicates these requests for data to the base station 102, which forwards the requests to the data network via one or more other components of the cellular network 100. In response to the requests, the data network provides data that is communicated to the base station 102. The base station 102 in turn provides the data to the user equipment 104 using the techniques described further herein. In at least one embodiment, the base station 102 is a small cell, such as a femtocell, that covers a relatively small geographic area, such as a single building or portion thereof, or supports a relatively small number of user equipment.

To communicate data to user equipment, the base station 102 employs one or more frequency channels. Each frequency channel is defined by a corresponding center frequency and a range of frequencies about the center frequency to communicate information using data transmission techniques understood by those skilled in the art. In some scenarios, the base station 102 employs LFCs (e.g., LFCs 116 and 118) to communicate data, wherein each LFC employs frequencies that have been licensed to the owner or operator of the base station 102. However, for LTE and other communication standards, the data rate per unit of bandwidth of each LFC is at or near its theoretical limit, and the frequencies of the licensed frequency spectrum are mostly licensed, such that the amount of data that can be communicated via the licensed frequency spectrum is limited. Accordingly, to increase data bandwidth the base station 102 can communicate data via the UFC 117. For example, the base station 102 can communicate LTE frames to the user equipment 106 via the LFC 116, with each LTE frame including data for one or more applications executing at the user equipment 106. For one or more of the LTE frames, the base station 102 can concurrently communicate data via the UFC 117 (or via multiple UFCs), thereby increasing the amount of data that can be communicated to the user equipment 106 for a given amount of time.

However, the use of the UFC 117 by the base station 102 can interfere with the operation of the WLAN 101. To illustrate, the cellular network 100 and the WLAN 101 overlap in an area 103. That is, area 103 represents a geographic area wherein signals between the base station 102 and user equipment, and signals between the wireless router 115 and endpoints can interfere with each other. This interference can cause, for example, poor communication between the wireless router 115 and the endpoint 108.

To reduce interference with the WLAN 101 on the UFC 117, the base station 102 communicates data via the UFC 117 selectively, based on whether or not it detects other devices using the UFC 117. For example, in at least one embodiment the base station 102 communicates data to the user equipment 106 over the LFC 116 via a set of LTE frames, each LTE frame representing an interval of data communication. For each LTE frame the base station 102 detects if a signal is present on the UFC 117. To perform signal detection, the base station 102 can employ a transceiver that “listens” on the UFC 117 and reports any signal on the UFC having a signal strength that exceeds a threshold. A signal exceeding the threshold is referred to as present on the UFC 117. A signal present on the UFC 117 indicates that the wireless router 115 is communicating information to an endpoint via the channel, and therefore that transmission of data on the UFC 117 by the base station 102 could interfere with the operation of the wireless router 115. Accordingly, in response to detecting that a signal is present on the UFC 117, the base station 102 communicates data to the user equipment 106 via an LTE frame on the LFC 116 but does not, for the length of the LTE frame, communicate data via the UFC 116. If the base station 102 does not detect a signal on the UFC 117, it communicates data on the UFC 117 to the user equipment 106 concurrent with communicating the LTE frame on the LFC 116. The base station 102 thereby increases the amount of data that is communicated to the user equipment 106 for the length of the LTE frame, since data is communicated via two different channels, while reducing interference with the WLAN 101.

In at least one embodiment, the length of an LTE frame is relatively long compared to the data communication requirements of the WLAN 101, so that communication of data via the UFC 117 for an entire LTE frame would significantly degrade the quality of service of WLAN 101. Accordingly, in response to determining that there is no signal present on the UFC 117, the base station 102 communicates data to the user equipment 106 via the UFC 117 for only a portion, and not all, of the duration of an LTE frame concurrently communicated via the LFC 116. This increases the amount of time that the wireless router 115 has to communicate data to, for example, the endpoint 108, without interference from the base station 102.

For purposes of description, the amount of time on the UFC 117 corresponding to communication of one LTE frame via the LFC 116 is referred to as a “UFC frame”. Thus, each LTE frame communicated over the LFC 116 has a corresponding UFC frame, representing the corresponding amount of time for communication of data over the UFC 117. The amount of time in a given UFC frame where the base station 102 communicates data is referred to herein as the “data subinterval” of the UFC frame, and the amount of time wherein the base station 102 suspends communicating data over the UFC frame is referred to herein as the “blank subinterval” of the UFC frame. For a UFC frame wherein, prior to the frame, a signal is detected on the UFC 117, the blank subinterval can be the entire length of the UFC frame (i.e. the data subinterval has a length of zero). For a UFC frame wherein no signal was detected on the UFC 117, the blank subinterval is only a portion of the frame, with data being communicated over the UFC 117 during the data interval of the UFC frame.

In some scenarios, the wireless router 115 may employ the UFC 117 relatively infrequently, such that the periods where it is not using the UFC 117 likely encompass multiple LTE frames and corresponding UFC frames. In such scenarios, it can be advantageous to use more of each UFC frame to communicate data. Accordingly, in at least one embodiment, the base station 102 can set the length of the blank subinterval for UFC frames based on whether a signal was detected on the UFC 117. For example, in response to a signal being detected on the UFC 117, the blank subinterval for one or more subsequent UFC frames can be lengthened. In response to no signal being detected on the UFC, the blank interval for subsequent UFC frames can be shortened. The base station 102 thereby adapts the amount of data it communicates over the UFC 117 based on how often it detects signals on the UFC 117.

In at least one embodiment, the base station 102 can coordinate its use of the UFC 117 with the wireless router 115 by issuing a reservation signal for the channel prior to communicating data via the channel. The reservation signal indicates to the wireless router 115 that the UFC 117 will be occupied for the length of one or more LTE frames. In response to the reservation signal, the wireless router 115 can refrain from using the UFC 117 for the length of time indicated by the reservation signal. This coordination between the base station 102 and the wireless router 115 can improve the quality of data communication for both devices. To illustrate employment of the reservation signal, in at least one embodiment, in response to detecting no signal on the UFC 117, the base station 102 communicates the reservation signal on the UFC 117. The reservation signal indicates to other devices operating on the UFC 117, such as the wireless router 115, that the base station 102 will be communicating data over the UFC 117 for a length of time specified in the reservation signal. These devices can then refrain from communicating signals on the UFC 117 for the indicated amount of time. In at least one embodiment the base station 102 can also receive reservation signals issued by other devices for the UFC, and refrain from employing the UFC 117 to communicate data for a specified amount of time in response to the reservation signals.

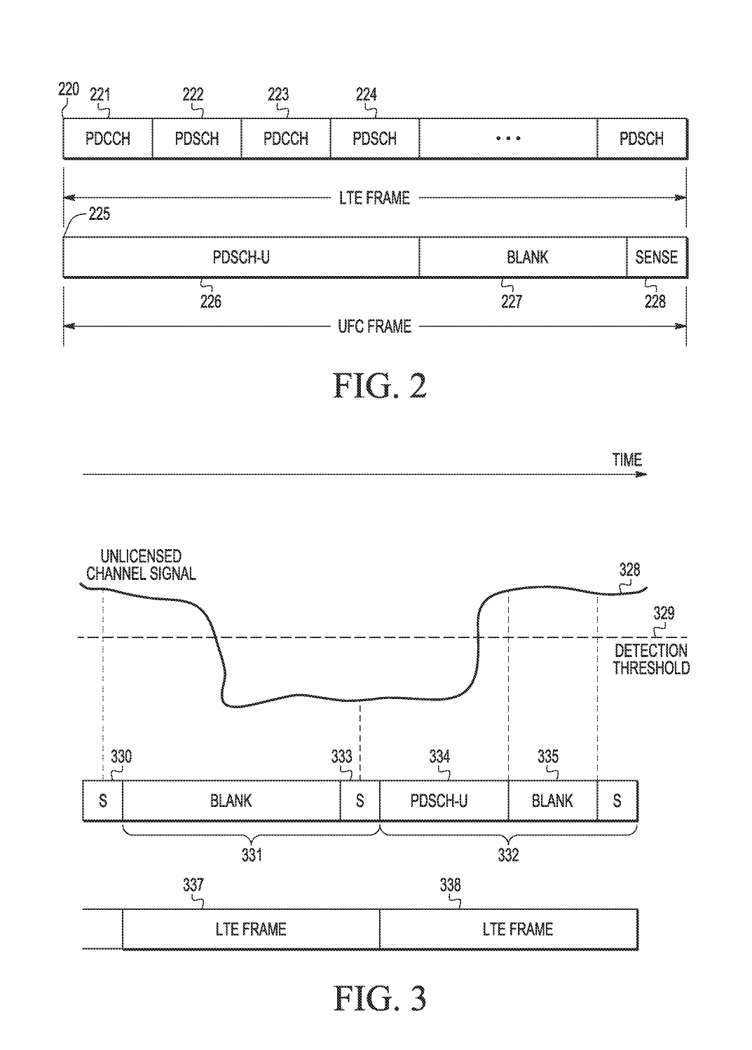

Using the above-described techniques, the base station 102 uses the LFC 116 as the main channel for communication of data to the user equipment 106, and opportunistically supplements the main channel with data communicated via the UFC 117. In at least one embodiment, the base station 102 determines whether to employ the UFC 117 on a frame-by-frame basis. This can be better understood with reference to FIG. 2, which illustrates an LTE frame 220 and a corresponding UFC frame 225 in accordance with at least one embodiment of the present invention. The LTE frame 220 and UFC frame 225 can be communicated to the user equipment 106 concurrently in order to increase the amount of data that can be communicated over a given amount of time.

The LTE frame 220 includes a plurality of intervals, referred to as subframes, in accordance with the LTE standard. The plurality of subframes includes control subframes such as control subframes 221 and 223, and data subframes such as data subframes 222 and 224. In at least one embodiment, the control subframes are physical downlink control channel (PDCCH) subframes, in accordance with the LTE standard, that include control information with respect to the data in the data subframes, such as downlink control information (DCI) indicating to the destination user equipment the resources required to receive and process the data included in the data subframes. The data subframes of the LTE frame 220 include payload data to be used by one or more applications executing at the user equipment 106. In at least one embodiment, the data subframes are formatted as physical downlink shared channel (PDSCH) subframes in accordance with the LTE standard.

The UFC frame 225 includes a data subinterval 226, a blank subinterval 227, and a sensing subinterval 228. During the data subinterval 226 the base station 102 communicates data over the UFC 117. In at least one embodiment, in order to facilitate processing of the data communicated during the data subinterval 226, the base station 102 formats the data as PDSCH data in accordance with the LTE standard. However, because data may be transmitted over the UFC 117 intermittently, PDCCH subframes are not communicated via the UFC 117. Accordingly, in at least one embodiment, the PDCCH subframes 221 and 223 provide control information both for the PDSCH subframes of the LFC 116, and for the PDSCH data communicated via the data subinterval 226 on the UFC 117. Thus, for example, the PDCCH subframes 221 and 223 can include resource assignment information for the data communicated via the data subinterval 226.

In at least one embodiment, while not communicating LTE control information via the UFC 117, the base station 102 can transmit one or more reference signals during the data subinterval 226 to allow user equipment to detect transmission of data on the UFC 117, and to synchronize clock signals or other timing signals to allow for proper decoding of the transmitted data. The one or more synchronization signals can be cell specific reference signals (CRS) similar to CRS signals transmitted in the LTE frame 220 via the LFC 116. By employing CRS signals in the UFC frame 225, the base station 102 supports detection and decoding of data communicated on the UFC 117 by user equipment using existing reception and decoding hardware.

The UFC frame 225 further includes a blank subinterval 227, during which the base station 102 refrains from communicating data on the UFC 117 in order to give other devices such as the wireless router 115 the opportunity to use the channel without interference from the base station 102. In at least one embodiment, the base station 102 synchronizes the beginning and end of the blank subinterval 227 with the beginning and end of subframes of the LTE frame 220. This ensures that the end of the data subinterval 226 is synchronized with the end of a subframe of the LTE frame 220, simplifying decoding and multiplexing of data at the user equipment. In at least one embodiment, the base station 102 synchronizes the beginning of the blank subinterval 227 with the beginning of a subframe of the LTE frame 220, but does not synchronize the end of the blank subinterval with an end of a subframe of the LTE frame 220.

The UFC frame 225 includes a sensing subinterval 228 during which the base station 102 senses whether a signal is present on the UFC 117. Based on this sensing, the base station 102 determines whether to include a data subinterval for the succeeding UFC frame, or whether to refrain from communicating data for the entire length of the succeeding UFC frame. Thus, for each LTE frame to be communicated via the LFC 116, the base station 102 senses, in advance of the LTE frame, to determine whether a signal is present on the UFC 117 and therefore whether to include a data subinterval in a corresponding UFC frame. Sensing signals in advance of each LTE frame allows the base station 102 sufficient time to coordinate control information and data transmission between LTE frames and corresponding UFC frames.

FIG. 3 illustrates a block diagram depicting communication of data on the UFC 117 based on the detection of a signal on the channel in accordance with at least one embodiment of the present invention. FIG. 3 illustrates a curve 328 representing the strength of signals on the UFC 117 generated by devices other than the base station 102. FIG. 3 also illustrates a detection threshold 329, representing the threshold used by the base station 102 to identify whether a signal is present on the UFC 117. That is, if the curve 328 is above the detection threshold 329 at a given point of time, the base station 102 will identify a signal as present on the UFC 117 at that time.

FIG. 3 further illustrates UFC frames 331 332 and corresponding LTE frames 337 and 338. In operation, during a sensing interval 330 of a UFC frame not illustrated at FIG. 3, the base station 102 identifies that a signal is present on the UFC 117. In response, the base station 102 does not communicate data during the succeeding UFC frame 331. Instead, the base station 102 only communicates data via the corresponding LTE frame 337.

During the sensing subinterval 333 of the UFC frame 331, the base station 102 does not identify a signal as present on the UFC 117. Accordingly, the base station 102 communicates data during a data subinterval 334 of the succeeding UFC frame 332, as well as communicating data via the corresponding LTE frame 338. The base station 102 thereby increases the amount of data that is communicated for the duration of the UFC frame 332 and the corresponding LTE frame 338. However, the base station 102 also includes a blank subinterval 335 in the UFC frame 332, during which it refrains from communicating data on the UFC 117. As illustrated at FIG. 3, there is a signal present on the UFC 117 during the blank subinterval 335, indicating that the wireless router 115 or other equipment is attempting to use the UFC 117. Thus, by including the blank subinterval 335, the base station 102 reduces interference with other devices using the UFC 117.

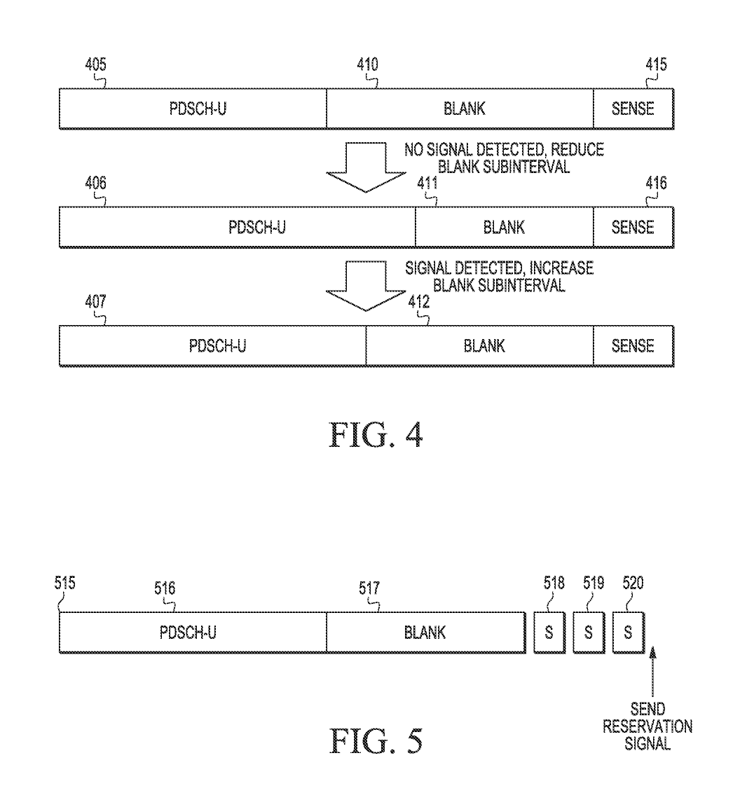

In some scenarios, the amount of usage of the UFC 117 by the wireless router 115 may vary substantially over time. For example, there may be an extended period where the wireless router 115 does not use the UFC 117 at all, followed by brief periods of frequent usage of the channel. To account for this variability, and increase the amount of data that can be communicated to user equipment via the UFC 117, the base station 102 can adjust the length of the blank intervals for UFC frames based on detection of signals on the UFC 117. An example of this adjustment is illustrated at FIG. 4 in accordance with at least one embodiment of the present invention. FIG. 4 depicts UFC frames 405, 406, and 407 representing a sequence of UFC frames. UFC frame 405 includes a blank subinterval of length N. The UFC frame 405 also includes a sense subinterval 415 during which the base station 102 does not detect a signal on the UFC 117. In response, the base station at 102 reduces the length of a blank subinterval 411 for the succeeding UFC frame 406 to a length M, where M is less than N. The base station 102 correspondingly increases the length of the data sub interval for the UFC frame 406, thereby increasing the amount of data that can be communicated to the user equipment.

During a sense subinterval 416 of the UFC frame 406, the base station 102 identifies a signal as present on the UFC 117. In response the base station 102 increases a length of the blank subinterval to length P, where P is greater than M. In at least one embodiment, the amount by which the base station 102 increases the blank interval can differ by the amount by which it previously decreased the blank interval, such that P is different from N. In at least one embodiment the length of the blank subinterval for a UFC frame is bounded by specified minimum and maximum lengths.

In some scenarios, rather than having periodic and fixed length sensing intervals, it can be useful for the base station 102 to repeatedly sense signals on the UFC 117, and communicating data via the UFC 117 only when no signal is present on the channel. An example is illustrated at FIG. 5, which depicts a block diagram of a UFC frame 515 including multiple sensing subintervals in accordance with at least one embodiment of the present invention. The UFC frame 515 includes a data sub interval 516 during which the base station 102 communicates data over the UFC 117, and a blank subinterval 517 during which the base station 102 refrains from communicating data over the UFC 117. After the blank subinterval 517, the base station 102 does not sense signals on the UFC 117 for a single sensing subinterval, but instead repeatedly senses signals on the UFC 117 for multiple sensing sub intervals (e.g., sensing subintervals 518, 519, and 520) until no signal is detected on the UFC 117. In response to not detecting a signal on the UFC 117 during a sensing subinterval, the base station 102 sends a reservation signal on the UFC 117 to indicate to other devices employing the UFC 117, such as the wireless router 115, that it will be communicating data on the UFC 117 were specified length of time. This allows the other devices to refrain from using the channel during the specified length of time, thereby reducing degradation in their communications.

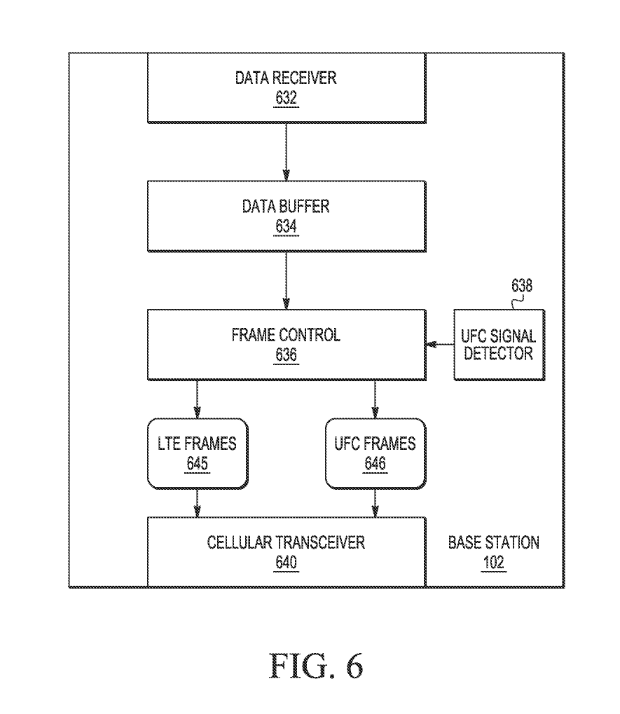

FIG. 6 illustrates a block diagram of the base station 102 in accordance with at least one embodiment of the present invention. In the illustrated example, the base station 102 includes a data receiver 632, a data buffer 634, a frame control module 636, a UFC signal detector 638, and a cellular transceiver 640. The data receiver 632 is a module generally configured to receive data targeted to user equipment, such as user equipment 106. The data can be received from another cellular base station, and ultimately originate from a data network such as the Internet. The data buffer 634 is a memory structure and associated control circuitry that stores the data received by the data receiver 632.

The UFC signal detector 638 is a module configured to detect signals on the UFC 117. In at least one embodiment, the UFC signal detector 638 include one or more antennae that receive wireless signals across a relatively broad spectrum of frequencies. The UFC signal detector 638 further includes a bandpass filter having a center frequency at or near a center frequency of the UFC 117, and includes a comparator connected to an output of the bandpass filter and connected to a voltage reference corresponding to a signal detection threshold. The comparator provides a digital signal indicating whether a signal exceeding the signal detection threshold is present on the UFC 117.

The frame control module 636 is a module, such as a processor, configured to form the data stored at the data buffer 634 into LTE frames 645 and UFC frames 646 for communication to the user equipment. To illustrate, in response to identifying that the data receiver 632 has stored data at the data buffer 634, the frame control module 636 initiates periodic formation of the data into frames over a set of intervals. For each interval, the frame control module 636 forms an LTE frame including control subframes and data subframes as illustrated above at FIG. 2. In addition, the frame control module 636 identifies, during a sensing subinterval, whether the UFC signal detector indicates that a signal is present on the UFC 117. If so, the frame control module 636 does not form a UFC frame for that interval, so that the base station 102 refrains from communicating data via the UFC 117 during that interval. If, during the sensing subinterval, the UFC signal detector 638 indicates no signal is present on the UFC 117, the frame control module 636 forms a UFC frame including a data subinterval having data to be communicated to the endpoint. In at least one embodiment, in response to forming a UFC frame, the frame control module 636 forms the corresponding LTE frame for the interval to include control information for the data to be communicated in the UFC frame.

The cellular transceiver 640 is configured to receive the LTE frames 645 and UFC frames 646 and to generate the cellular network signals to communicate the frames to their targeted user equipment. The cellular transceiver can manage physical (PHY) layer operations, including symbol delivery, signal formation and transmission, flow control operations, channel coding, and the like. In at least one embodiment, the cellular transceiver 640 generates CRS for both the LTE frames 645 and UFC frames 646, allowing the targeted user equipment to detect transmission of the frames over their respective channels, and to properly decode the data communicated via the frames.

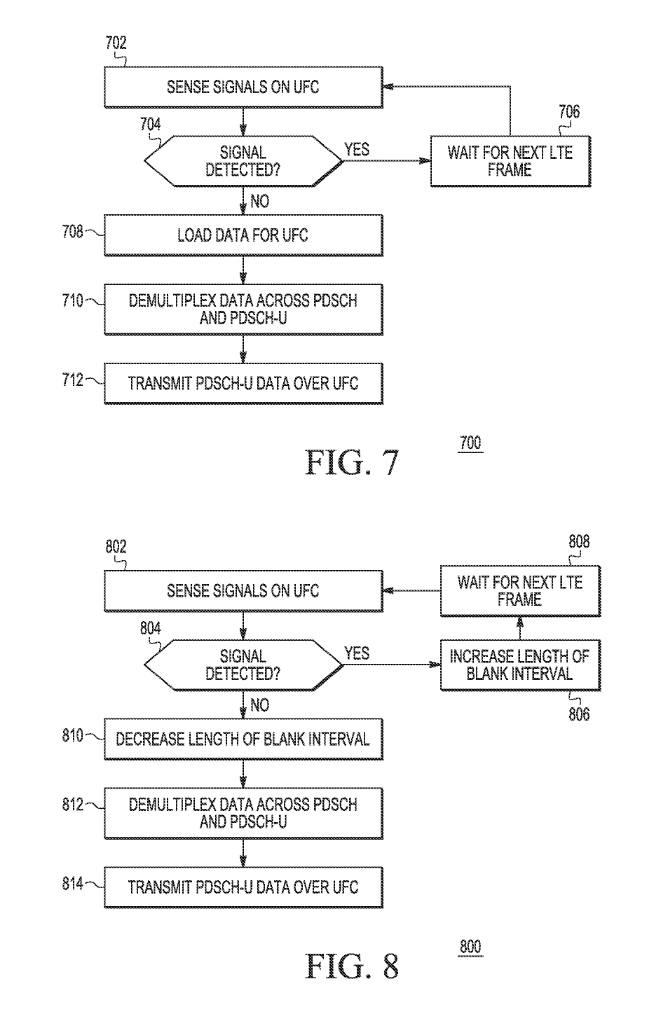

FIG. 7 illustrates a flow diagram of a method 700 of communicating data from a base station over an unlicensed frequency channel in accordance with at least one embodiment of the present invention. For purposes of description, the method 700 is described with respect to an example implementation at the base station 102 of FIG. 6. At block 702, the UFC signal detector 638 senses signals on the UFC 117. At decision block 704, the frame control module 636 identifies whether the UFC signal detector 638 indicates that a signal is present on the UFC 117. The frame control module thus determines the availability of the UFC 117 for communication of data. If a signal is present, the UFC 117 is not available, and the method flow moves to block 706 where the frame control module 636 places data in one of the LTE frames 645 for communication via the cellular transceiver 640. The frame control module 636 refrains from communicating any data via a UFC frame concurrent with the LTE frame. The frame control module 636 awaits the time for generation of the next LTE frame, and the method flow returns to block 702.

Returning to block 704, if the frame control module 636 determines that the UFC signal detector 638 indicates no signal is present on the UFC 117, the UFC 117 is available. Accordingly, the method flow moves to block 708 and the frame control module 636 retrieves data from the data buffer 634 for communication via both an LTE frame and a UFC frame. At block 710, the frame control module 636 multiplexes the selected data across data subframes of an LTE frame and a data subinterval of a UFC frame. At block 712, the cellular transceiver 640 communicates the UFC frame over the UFC 117. In at least one embodiment, the UFC frame includes a blank interval wherein the base station 102 refrains from communicating data via the UFC 117.

FIG. 8 illustrates a flow diagram of a method 800 of adjusting the length of a blank interval of a UFC frame in accordance with one embodiment of the present invention. For purposes of description, the method 800 is described with respect to an example implementation at the base station 102 of FIG. 6. At block 802, the UFC signal detector 638 sense signals on the UFC 117. At decision block 804, the frame control module 636 identifies whether the UFC signal detector 638 indicates that a signal is present on the UFC 117. If a signal is present, the method flow moves to block 806 and the frame control module 636 decreases the length of the blank interval to be used in subsequent UFC frames. The method flow proceeds to block 808 and the frame control module 636 places data in one of the LTE frames 645 for communication via the cellular transceiver 640. The frame control module 636 refrains from communicating any data via a UFC frame concurrent with the LTE frame. The frame control module 636 awaits the time for generation of the next LTE frame, and the method flow returns to block 802.

Returning to block 804, if the frame control module 636 determines that the UFC signal detector 638 indicates no signal is present on the UFC 117, the method flow moves to block 810 and the frame control module 636 increases the length of the blank interval to be used for subsequent UFC frames. At block 812 the frame control module 636 retrieves data from the data buffer 634 for communication via both an LTE frame and a UFC frame and multiplexes the selected data across data subframes of an LTE frame and a data subinterval of a UFC frame. At block 814, the cellular transceiver 640 communicates the UFC frame over the UFC 117, with the UFC frame including a blank interval wherein the base station 102 refrains from communicating data via the UFC 117, the blank interval having a length based on the increases and decreases implemented at blocks 806 and 810.

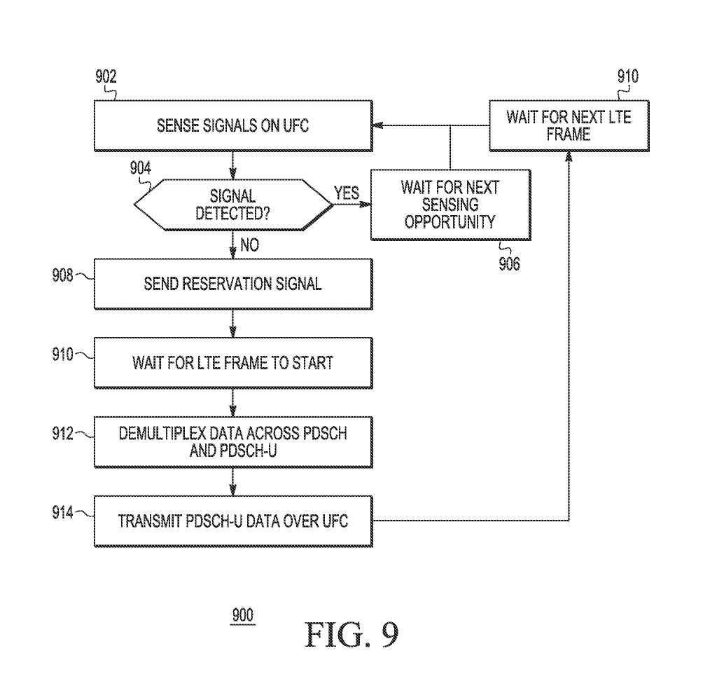

FIG. 9 illustrates a flow diagram of a method 900 of sending a reservation signal from a base station prior to communicating data via a UFC in accordance with one embodiment of the present invention. For purposes of description, the method 900 is described with respect to an example implementation at the base station 102 of FIG. 6. At block 902, the UFC signal detector 638 sense signals on the UFC 117. At decision block 904, the frame control module 636 identifies whether the UFC signal detector 638 indicates that a signal is present on the UFC 117. If a signal is present, the method flow moves to block 906 and the frame control module 636 waits a specified amount of time before the method flow returns to block 902. Thus, the frame control module 636 repeatedly senses signals on the UFC 117 until it determines that no signal is present.

Returning to block 904, if the frame control module 636 determines that the UFC signal detector 638 indicates no signal is present on the UFC 117, the method flow moves to block 908 and the frame control module 636 controls the cellular transceiver 640 to issue a reservation signal on the UFC 117, indicating to other devices using that channel that the base station 102 intends to communicate data over the channel. This allows the other devices to take action in order to prevent degradation in their communications, such as refraining from using the channel during the time indicated by the reservation signal, switching to a different channel for communications, and the like. At block 910 the frame control module synchronizes formation of a UFC frame so that it will be transmitted concurrently with the next LTE frame to be transmitted. At block 912 the frame control module 636 retrieves data from the data buffer 634 for communication via both an LTE frame and a UFC frame and multiplexes the selected data across data subframes of an LTE frame and a data subinterval of a UFC frame. In at least one embodiment, because the reservation signal was sent to reserve the UFC 117, the UFC frame does not include a blank subinterval, or includes a relatively short blank subinterval. The method flow moves to block 906 where the frame control module waits for the start of transmission of another LTE frame, before returning to block 902 to again sense the presence of signals on the UFC 117.

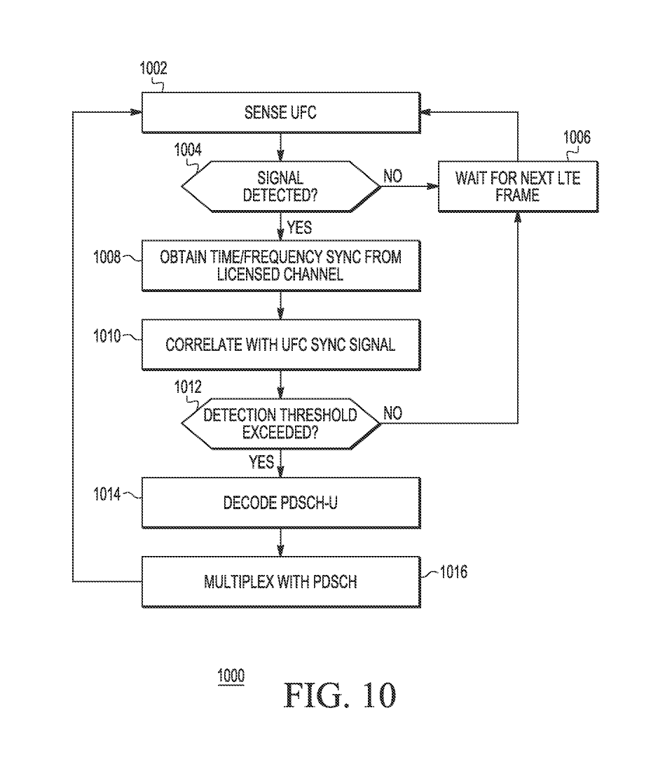

FIG. 10 illustrates a flow diagram of a method 1000 of receiving data at user equipment, such as a smartphone, via a UFC in accordance with at least one embodiment of the present invention. For purposes of description, the method 1000 is described with the respect to an example implementation at the user equipment 106 of FIG. 1. At block 1002, the user equipment 106 senses signals on the UFC 117. In at least one embodiment, in order to sense signal the user equipment 106 includes one or more antennas to receive wireless signals, and a bandpass filter having a center frequency corresponding to the center frequency of the UFC 117. The user equipment 106 further includes a comparator or other circuitry to compare an output of the bandpass filter to a threshold voltage, and identifies, at block 1004, whether a signal is present on the UFC in based on a comparison of the output of the bandpass filter to the threshold voltage. If, at block 1004, the user equipment 106 determines that no signal is present on the UFC 117, the method flow proceeds to block 1006, and the user equipment 106 waits until it expects to receive another LTE frame. The method flow then returns to block 1002.

Returning to block 1004, if the user equipment 106 senses that a signal is present on the UFC 117, this indicates that the base station 102 may be communicating data via the channel. Accordingly, the method flow proceeds to block 1008 and the user equipment 106 obtains time and frequency synchronization information for the UFC 117 from control subframes received via the LFC 116. At block 1010, based on the time and frequency synchronization information the user equipment 106 attempts to correlate with a CRS on the UFC 117. At block 1012, based on the correlation attempts, the user equipment 106 determines whether a detection threshold for the CRS has been exceeded, indicating the presence of a CRS. If the detection threshold has not been exceeded, the method flow proceeds to block 1006, described above.

If, at block 1012, the user equipment 106 determines that the detection threshold has been exceeded, and therefore that a CRS has been detected on the UFC 117, the method flow moves to block 1014 and the user equipment 106 uses the CRS to decode data received via the UFC 117. The method flow proceeds to block 1016 and the user equipment 106 multiplexes the decoded data with data received via a corresponding LTE frame over the LFC 116, so that the data is ready to be provided to one or more applications executing at the user equipment 106. The method flow then returns to block 1002.

In some embodiments, certain aspects of the techniques described above may implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
in response to determining at the cellular base station that an unlicensed frequency channel is available for data communication:
generating a first frame of data including a first portion of the first data targeted to user equipment;
communicating the first frame of data via a licensed frequency channel for a first interval;
communicating a second portion of the first data via the unlicensed frequency channel for a first subinterval of the first interval; and
subsequently suspending communication of data via the unlicensed frequency channel for a blank subinterval of the first interval.

2. The method of claim 1, further comprising:
in response to determining at the cellular base station that the unlicensed frequency channel is not available for data communication, communicating the first frame of data via the licensed frequency channel for the first interval and suspending communication of data via the unlicensed frequency channel during the first interval.

3. The method of claim 1, further comprising:
setting a length of the blank subinterval in response to detecting a signal on the unlicensed frequency channel.

4. The method of claim 3, wherein setting the length of the blank subinterval comprises increasing the length of the blank subinterval in response to not detecting a signal on the unlicensed frequency channel.

5. The method of claim 3, wherein setting of the length of the blank subinterval comprises decreasing the length of the blank subinterval in response to detecting a signal on the unlicensed frequency channel.

6. The method of claim 1, further comprising:
after communicating the first frame of data, sensing one or more signals on the unlicensed frequency channel to determine an availability of the unlicensed frequency channel.

7. The method of claim 6, further comprising:
in response to determining the unlicensed frequency channel is available based on the sensing, communicating second data via the unlicensed frequency channel.

8. The method of claim 6, wherein sensing signals on the unlicensed frequency channel comprises sensing one or more signals a plurality of times.

9. The method of claim 1, further comprising:
communicating a reference signal via the unlicensed frequency channel during the first subinterval.

10. A method comprising:
detecting, at a mobile device, a signal on unlicensed frequency channel:
receiving first data via a licensed frequency channel;
receiving second data via an unlicensed frequency channel; and
multiplexing the first and second data to form a first frame of data.

11. The method of claim 10, further comprising:
synchronizing receipt of the first data based on a synchronization signal received via the unlicensed frequency channel.

12. A cellular base station, comprising:
a frame control module to:
in response to determining that an unlicensed frequency channel is available for data transmission:
generate a first frame of data including a first portion of first data targeted to user equipment;
communicate the first frame of data via a licensed frequency channel for a first interval;
communicate a second portion of the first data of via the unlicensed frequency channel for a first subinterval of the first interval; and
subsequently suspending communication of data via the unlicensed frequency channel for a blank subinterval of the first interval.

13. The cellular base station of claim 12, wherein the frame control module is to:
in response to determining at the base station that the unlicensed frequency channel is not available, communicate the first frame of data via the licensed frequency channel for the first interval and suspending communication of data via the unlicensed frequency channel during the first interval.

14. The cellular base station of claim 12, wherein the frame control module is to:
set a length of the blank subinterval in response to detecting a signal on the unlicensed frequency channel.

15. The cellular base station of claim 14, wherein the frame control module is to set the length of the blank subinterval by increasing the length of the blank subinterval in response to not detecting a signal on the unlicensed frequency channel.

16. The cellular base station of claim 15, wherein the frame control module is to set the length of the blank subinterval by decreasing the length of the blank subinterval in response to detecting a signal on the unlicensed frequency channel.

17. The cellular base station of claim 12, further comprising:
a signal detector to, after the frame control module has communicated the first frame of data, sense one or more signals on the unlicensed frequency channel to determine an availability of the unlicensed frequency channel.

18. The cellular base station of claim 17, wherein the frame control module is to:
in response to the signal detector determining the unlicensed frequency channel is available based on the sensing, communicate second data via the unlicensed frequency channel.

19. The cellular base station of claim 17, wherein the signal detector is to sense one or more signals on the unlicensed frequency channel a plurality of times.

20. The cellular base station of claim 12, wherein the frame control module is to:
communicate a synchronization signal via the unlicensed frequency channel during the first subinterval.
